(19) United States
(12) Patent Application Publication
(10) Pub. No.: US 2013/0011751 A1
(43) Pub. Date: Jan. 10, 2013

(54) METAL OXYGEN BATTERY

(75) Inventors: Satoshi NAKADA, Saitama (JP); Yuji ISOGAI, Saitama (JP); Kiyoshi TANAAMI, Saitama (JP); Takuya TANIUCHI, Saitama (JP); Taichi GOTO, Oita (JP); Yuka NAGATOCHI, Saitama (JP)

(73) Assignee: HONDA MOTOR CO., LTD., Tokyo (JP)

(21) Appl. No.: 13/541,713

(22) Filed: Jul. 4, 2012

(30) Foreign Application Priority Data
Jul. 4, 2011 (JP) 2011-148477
Jul. 3, 2012 (JP) 2012-149151

(51) Int. Cl. H01M 12/08

(52) U.S. Cl. 429/405

(57) ABSTRACT

There is provided a metal oxygen battery which uses an oxygen-storing material of a composite oxide containing Y and Mn as a positive electrode material, and can reduce the reaction overpotential. The metal oxygen battery 1 has a positive electrode 2 to which oxygen is applied as an active substance, a negative electrode 3 to which metallic lithium is applied as an active substance, and an electrolyte layer 4 interposed between the positive electrode 2 and the negative electrode 3. The positive electrode 2 contains an oxygen-storing material of YMn₁₋ₓAₓO₃ wherein A=Ru, Ni, or Co, and 0.01≦x≦0.2.

### BACKGROUND OF THE INVENTION

1. Field of the Invention

The present invention relates to a metal oxygen battery.

2. Description of the Related Art

Metal oxygen batteries have conventionally been known, which have a positive electrode using oxygen as an active substance, a negative electrode using a metal as an active substance, and an electrolyte layer interposed between the positive electrode and the negative electrode.

In the metal oxygen batteries, in the discharge time, a metal is oxidized to form metal ions at the negative electrode, and the formed metal ions permeate through the electrolyte layer and migrate into the positive electrode side. On the other hand, at the positive electrode, oxygen is reduced to form oxygen ions, and the formed oxygen ions bond with the metal ions to form a metal oxide.

In the charge time, at the positive electrode, metal ions and oxygen ions are formed from the metal oxide, and the formed oxygen ions are oxidized to become oxygen. On the other hand, the metal ions permeate through the electrolyte layer and migrate into the negative electrode side, and reduced to become the metal at the negative electrode.

In the metal oxygen battery, if metallic lithium is used as the metal, since the metallic lithium has a high theoretical voltage and a large electrochemical equivalent weight, the metal oxygen battery can provide a large capacity. If oxygen in the air is used as the oxygen, since there is no need for filling a positive electrode active substance in a battery, the energy density per mass of the battery can be raised.

However, if the positive electrode is exposed to the atmosphere in order to make oxygen in the air to be a positive electrode active substance, moisture, carbon dioxide and the like in the air invade in the battery, and there is caused a problem of deterioration of the electrolyte, the negative electrode and the like. Then, in order to solve the problem, a metal oxygen battery is known, which has a positive electrode containing an oxygen-occluding material to release oxygen by reception of light, a negative electrode composed of metallic lithium, and an electrolyte layer disposed in a hermetically sealed case, and has a light transmission part to guide light to the oxygen-occluding material (for example, see Japanese Patent Laid-Open No. 2009-230985).

The metal oxygen battery can release oxygen from the oxygen-occluding material by guiding light to the oxygen-occluding material through the light transmission part, and can provide oxygen as a positive electrode active substance without exposing the positive electrode to the atmosphere. Therefore, the deterioration of the electrolyte, the negative electrode and the like due to the invasion of moisture, carbon dioxide and the like into the battery can be prevented.

However, in the conventional metal oxygen battery, the supply of oxygen becomes unstable in the absence of irradiation of light rays, and there is a risk that the light transmission part, which is weaker than other parts of the hermetically sealed case, is broken and the electrolyte solution leaks out. Then, it is conceivable that an oxygen-storing material which does not rely on irradiation of light rays and can occlude and release oxygen chemically, or adsorb and desorb oxygen physically is used as a positive electrode material of the metal oxygen battery. The oxygen-storing material includes YMnO₃.

However, in a metal oxygen battery using an oxygen-storing material composed of YMnO₃ as the positive electrode material, the reaction overpotential becomes high, resulting in disadvantages that the charge and discharge efficiency decreases and a high power output cannot be attained.

### SUMMARY OF THE INVENTION

It is an object of the present invention to eliminate such disadvantages and provide a metal oxygen battery which uses an oxygen-storing material comprising a composite oxide containing Y and Mn as a positive electrode material and whose reaction overpotential can be decreased.

The present inventors have studied causes of the reaction overpotential becoming high when an oxygen-storing material comprising YMnO₃ is used as a positive electrode material of a metal oxygen battery. As a result, it has been found that YMnO₃ is an electron insulator and becomes an obstacle in electron transfer involved in redox of lithium ions on the surface thereof.

The present invention has been achieved based on the finding; and in order to achieve the above-mentioned object, in a metal oxygen battery comprising a positive electrode to which oxygen is applied as an active substance, a negative electrode to which metallic lithium is applied as an active substance, and an electrolyte layer interposed between the positive electrode and the negative electrode, the positive electrode contains an oxygen-storing material comprising YMn₁₋ₓAₓO₃ wherein A=Ru, Ni, or Co, and 0.01≦x≦0.2.

In the metal oxygen battery according to the present invention, in the discharge, metallic lithium is oxidized to form lithium ions and electrons at the negative electrode as shown in the following formula, and the formed lithium ions permeate through the electrolyte layer and migrate into the positive electrode. On the other hand, at the positive electrode, oxygen released or desorbed from the oxygen-storing material is reduced to form oxygen ions, and the formed oxygen ions react with the lithium ions to form lithium oxide or lithium peroxide. Then, by connecting the negative electrode and the positive electrode by a lead wire, an electric energy can be taken out.

(Negative Electrode) 4Li→4Li→4e⁻

(Positive Electrode) O₂+4e⁻+2O²⁻
a. 4Li⁺+2O²⁻→2Li₂O
b. 2Li³⁰+2O²⁻→Li₂O₂

In the charge time, lithium ions and oxygen ions are formed from lithium oxide or lithium peroxide at the positive electrode as shown in the following formulae, and the formed lithium ions permeate through the electrolyte layer and migrate into the negative electrode. The formed oxygen ions are occluded or adsorbed as they are or as oxygen molecules formed by oxidation of the oxygen ions in or on the oxygen-storing material. At the negative electrode, the lithium ions are reduced and deposited as metallic lithium.

(Positive Electrode) 2Li₂O→4Li⁺+2O²⁻
a. Li₂O₂→2Li⁺+2O²⁻

(Negative Electrode) 4Li⁺+4e⁻→4Li

In the metal oxygen battery according to the present invention, YMn₁₋ₓAₓO₃ (A=Ru, Ni, or Co) used as the oxygen-storing material is a substance in which Ru, 1 to 20 mol % (0.01≦x≦0.2), preferably 5 to 20 mol % (0.05≦x≦0.2), of Mn in YMnO₃ is replaced by Ru, Ni or Co.

Here, it is conceivable that the replacement of Mn in YMnO₃ by Sc, Ti, V, Cr, Fe, Co, Ni, Ru or the like, which are a 3d-transistion metal to form a subsitutional solid solution develops the electron conductivity. However, although for Sc, Ti, V, Cr and Fe, a decrease in the band gap is anticipated, no conductivity in the range measurable at room temperature is developed. By contrast, since Ru, Ni and Co have a large numbers of valence electrons, the replacement of Mn in YMnO₃ by Ru, Ni or Co to form a substitutional solid solution conceivably causes the electron cloud of Ru, Ni or Co to be nonlocalized in the YMnO₃ lattice, and the conductivity to be developed.

Since the redox reaction of lithium ions at the positive electrode is carried out on particles of the oxygen-storing material, using the YMn₁₋ₓAₓO₃ which has a conductivity as the oxygen-storing material can carry out smoothly the transfer of electrons in the redox reaction.

Therefore, the metal oxygen battery according to the present invention can reduce the reaction overpotential at the positive electrode, and provide an excellent charge and discharge efficiency and a high power output.

In YMn₁₋ₓO₃, if Ru, Ni or Co replacing Mn is less than 1 mol % of Mn, no conductivity can be attained. Even if Ru, Ni or Co exceeds 20 mol % of Mn, no conductivity higher than that at 20 mol % can be attained.

In the metal oxygen battery according to the present invention, the positive electrode may comprise the oxygen-storing material, a conductive material and a binder, and may further contain a lithium compound. The lithium compound includes, for example, lithium oxide and lithium peroxide.

In the case where the positive electrode comprises the oxygen-storing material, a conductive material, a binder, and a lithium compound, lithium ions formed at the positive electrode in the charge time deposit uniformly on metallic lithium of the negative electrode. Therefore, at the negative electrode, on repetition of dissolution and deposition of lithium, the lithium scarcely varies in its position, allowing the prevention of the formation of irregularities on the negative electrode surface and the suppression of a rise in the overpotential.

At this time, since the lithium compound closely contacts with the oxygen-storing material, the decomposition reaction of the lithium compound smoothly progresses due to a catalytic action of the oxygen-storing material. Therefore, the activation energy of the decomposition reaction of the lithium compound in the charge time can be reduced, allowing the further suppression of a rise in the overpotential.

In the metal oxygen battery according to the present invention, the positive electrode, the negative electrode and the electrolyte layer are preferably disposed in a hermetically sealed case. In the metal oxygen battery according to the present invention, the oxygen-storing material can chemically occlude and release or physically adsorb and desorb oxygen. Therefore, in the metal oxygen battery according to the present invention, oxygen as an active substance can be obtained at the positive electrode disposed in the hermetically sealed case instead of exposing the positive electrode to the atmosphere and forming a weak light transmission part, and there is no risk of the deterioration by moisture and carbon dioxide in the atmosphere and the leakage of an electrolyte solution by damage to the light transmission part.

Although in the case where the oxygen-storing material occludes and releases oxygen, the formation and dissociation of a chemical bond with oxygen is involved, in the case where oxygen is adsorbed on and desorbed from the surface, only an intermolecular force acts, and no formation and dissociation of a chemical bond is involved.

Therefore, the adsorption and desorption of oxygen on and from the surface of the oxygen-storing material is carried out with a lower energy than the case where the oxygen-storing material occludes and releases oxygen, and oxygen adsorbed on the surface of the oxygen-storing material is preferentially used in the battery reaction. Consequently, a decrease in the reaction rate and a rise in the overpotential can be suppressed.

At this time, in the metal oxygen battery according to the present invention, use of YMn₁₋ₓAₓO₃ (A=Ru, Ni, Co, 0.01≦x≦0.2) as the oxygen-storing material can increase the oxygen amount adsorbed on the surface. Therefore, the metal oxygen battery according to the present invention can provide also an effect of increasing the discharge capacity.

### BRIEF DESCRIPTION OF THE DRAWINGS

FIG. 1 is an illustrative cross-sectional diagram showing one constitution example of the metal oxygen battery according to the present invention;

FIG. 2 is a graph showing comparisons in conductivity between YMn₁₋ₓAₓO₃ and YMnO₃;

FIG. 3 is graphs showing charge and discharge curves in one embodiment of the metal oxygen battery according to the present invention;

FIG. 4 is graphs showing charge and discharge curves in use of YMn_{0.8}Co_{0.2}O₃ calcined at a temperature of 850° C. as the oxygen-storing material in another embodiment of the metal oxygen battery according to the present invention;

FIG. 5 is graphs showing charge and discharge curves in use of YMn_{0.8}Co_{0.2}O₃ calcined at a temperature of 1,000° C. as the oxygen-storing material, and a conductivity of the oxygen-storing material in another embodiment of the metal oxygen battery according to the present invention;

FIG. 6 is graphs showing charge and discharge curves in use of YMn_{0.9}Co_{0.1}O₃ calcined at a temperature of 850° C. as the oxygen-storing material in another embodiment of the metal oxygen battery according to the present invention;

FIG. 7 is graphs showing charge and discharge curves in use of YMn_{0.9}Co_{0.1}O₃ calcined at a temperature of 1,000° C. as the oxygen-storing material in another embodiment of the metal oxygen battery according to the present invention;

FIG. 8 is graphs showing charge and discharge curves in use of YMn_{0.95}Co_{0.05}O₃ calcined at a temperature of 850° C. as the oxygen-storing material in another embodiment of the metal oxygen battery according to the present invention;

FIG. 9 is graphs showing charge and discharge curves in use of YMn_{0.95}Co_{0.05}O₃ calcined at a temperature of 1,000° C. as the oxygen-storing material in another embodiment of the metal oxygen battery according to the present invention;

FIG. 10 is graphs showing charge and discharge curves in use of YMn_{0.8}Ni_{0.2}O₃ calcined at a temperature of 850° C. as the oxygen-storing material, and a conductivity of the oxygen-storing material in another embodiment of the metal oxygen battery according to the present invention;

FIG. 11 is graphs showing charge and discharge curves in use of YMn_{0.8}Ni_{0.2}O₃ calcined at a temperature of 1,000° C. as the oxygen-storing material, and a conductivity of the oxygen-storing material in another embodiment of the metal oxygen battery according to the present invention;

FIG. 12 is graphs showing charge and discharge curves in use of YMn_{0.9}Ni_{0.1}O₃ calcined at a temperature of 850° C. as the oxygen-storing material, and a conductivity of the oxygen-storing material in another embodiment of the metal oxygen battery according to the present invention;

FIG. 13 is graphs showing charge and discharge curves in use of YMn_{0.9}Ni_{0.1}O₃ calcined at a temperature of 1,000° C. as the oxygen-storing material, and a conductivity of the oxygen-storing material in another embodiment of the metal oxygen battery according to the present invention;

FIG. 14 is graphs showing charge and discharge curves in use of YMn_{0.95}Ni_{0.05}O₃ calcined at a temperature of 850° C. as the oxygen-storing material, and a conductivity of the oxygen-storing material in another embodiment of the metal oxygen battery according to the present invention;

FIG. 15 is graphs showing charge and discharge curves in use of YMn_{0.95}Ni_{0.05}O₃ calcined at a temperature of 1,000° C. as the oxygen-storing material in another embodiment of the metal oxygen battery according to the present invention;

FIG. 16 is graphs showing charge and discharge curves in use of YMn_{0.8}Ru_{0.2}O₃ calcined at a temperature of 850° C. as the oxygen-storing material in another embodiment of the metal oxygen battery according to the present invention;

FIG. 17 is graphs showing charge and discharge curves in use of YMn_{0.8}Ru_{0.2}O₃ calcined at a temperature of 1,000° C. as the oxygen-storing material, and a conductivity of the oxygen-storing material in another embodiment of the metal oxygen battery according to the present invention;

FIG. 18 is graphs showing charge and discharge curves in use of YMn_{0.9}Ru_{0.1}O₃ calcined at a temperature of 850° C. as the oxygen-storing material in another embodiment of the metal oxygen battery according to the present invention;

FIG. 19 is graphs showing charge and discharge curves in use of YMn_{0.9}Ru_{0.1}O₃ calcined at a temperature of 1,000° C. as the oxygen-storing material, and a conductivity of the oxygen-storing material in another embodiment of the metal oxygen battery according to the present invention;

FIG. 20 is graphs showing charge and discharge curves in use of YMn_{0.95}Ru_{0.05}O₃ calcined at a temperature of 850° C. as the oxygen-storing material in another embodiment of the metal oxygen battery according to the present invention; and

FIG. 21 is graphs showing charge and discharge curves in use of YMn_{0.95}Ru_{0.05}O₃ calcined at a temperature of 1,000° C. as the oxygen-storing material, and a conductivity of the oxygen-storing material in another embodiment of the metal oxygen battery according to the present invention.

### DETAILED DESCRIPTION OF THE PREFERRED EMBODIMENTS

Then, embodiments according to the present invention will be described in more detail by reference to accompanying drawings.

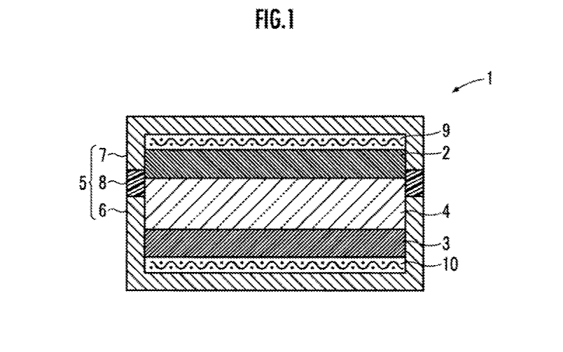

As shown in FIG. 1, a metal oxygen battery 1 according to the present embodiment comprises a positive electrode 2 using oxygen as an active substance, a negative electrode 3 using metallic lithium as an active substance, and an electrolyte layer 4 disposed between the positive electrode 2 and the negative electrode 3, and the positive electrode 2, the negative electrode 3 and the electrolyte layer 4 are hermetically accommodated in a case 5.

The case 5 comprises a cup-shape case body 6, and a lid body 7 to close the case body 6, and an insulating resin 8 is interposed between the case body 6 and the lid body 7. The positive electrode 2 has a positive electrode current collector 9 between the top surface of the lid body 7 and the positive electrode 2, and a negative electrode 3 has a negative electrode current collector 10 between the bottom surface of the case body 6 and the negative electrode 3. Here, in the metal oxygen battery 1, the case body 6 acts as a negative electrode plate, and the lid body 7 acts as a positive electrode plate.

In the metal oxygen battery 1, the positive electrode 2 may comprise an oxygen-storing material, a conductive material and a binder, and may further contain a lithium compound. The lithium compound includes, for example, lithium oxide and lithium peroxide.

The oxygen-storing material comprises YMn₁₋ₓAₓO₃ (A=Ru, Ni, Co). YMn₁₋ₓAₓO₃ is a substance in which 1 to 20 mol % (0.01≦x≦0.2), preferably 5 to 20 mol % (0.05≦x≦0.2) of Mn in YMnO₃ is replaced by Ru, Ni or Co, and has a conductivity. The oxygen-storing material has a function of occluding and releasing oxygen, and can adsorb and desorb oxygen on and from the surface.

The oxygen-storing material can be obtained, for example, by calcining a mixture of a reaction product, which is obtained by a reaction of a mixture of at least one compound of a yttrium compound, a manganese compound, a ruthenium compound, a nickel compound and a cobalt compound with an organic acid at a temperature in the range of 250 to 350° C., at a temperature in the range of 850 to 1,000° C. As the compounds, nitrate salts of respective metals of Y, Mn, Ru, Ni and Co can be used. As the organic acid, for example, malic acid can be used.

The conductive material includes, for example, carbon materials such as graphite, acetylene black, Ketjen Black, carbon nanotubes, mesoporous carbon and carbon fibers.

The binder includes polytetrafluoroethylene (PTFE), and polyvinylidene fluoride (PVDF).

Then, the electrolyte layer 4 may be, for example, one in which a nonaqueous electrolyte solution is immersed in a separator, or a solid electrolyte.

The nonaqueous electrolyte solution usable is, for example, one in which a lithium compound is dissolved in a nonaqueous solvent. The lithium compound includes, for example, carbonate salts, nitrate salts, acetate salts, lithium hexafluorophosphate (LiPF₆) and lithium bis(trifluoromethanesulfonyl)imide (LiTFSI). The nonaqueous solvent includes, for example, carbonate esteric solvents, etheric solvents and ionic liquids.

The carbonate esteric solvent includes, for example, ethylene carbonate, propylene carbonate, dimethyl carbonate and diethyl carbonate. The carbonate esteric solvent may be used as a mixture of two or more.

The etheric solvent includes, for example, dimethoxyethane, dimethyltriglyme and polyethylene glycol. The etheric solvent may be used as a mixture of two or more.

The ionic liquid includes, for example, salts of cations such as imidazolium, ammonium, pyridinium and piperidinium, with anions such as bis(trifluoromethylsulfonyl)imide (TTSI), bis(pentafluoroethylsulfonyl)imide (BETI), tetrafluoroborates, perchlorates and halogen anions.

The separator includes, for example, glass fibers, glass papers, polypropylene nonwoven fabrics, polyimide nonwoven fabrics, polyphenylene sulfide nonwoven fabrics, polyethylene porous films and polyolefin flat membranes.

The solid electrolyte includes, for example, oxide-based solid electrolytes and sulfide-based solid electrolytes.

The oxide-based solid electrolytes includes, for example, Li₇La₃Zr₂O₁₂, which is a composite oxide of lithium, lanthanum and zirconium, and glass ceramics containing lithium, aluminum, silicon, titanium, germanium and phosphorus as main components. The Li₇La₃Zr₂O₁₂ may be one in which another metal such as strontium, barium, silver, yttrium, lead, tin, antimony, hafiiium, tantalum and niobium is substituted for a part of each of lithium, lanthanum and zirconium.

Then, the current collectors 9 and 10 includes ones composed of meshes of titanium, stainless steel, nickel, aluminum, copper or the like.

In the metal oxygen battery 1 according to the present embodiment, in the discharge time, metallic lithium is oxidized to form lithium ions and electrons at the negative electrode 3 as shown in the following formula. The formed lithium ions migrate into the positive electrode 2, and react with oxygen ions formed by reduction of oxygen supplied from the oxygen-storing material to form lithium oxide or lithium peroxide.

(Negative Electrode) 4Li→4Li⁺+4e⁻

(Positive Electrode) O₂+4e⁻→2O²⁻
a. 4Li⁺+2O²⁻→2Li₂O
b. 2Li⁺+2O²⁻→Li₂O₂

On the other hand, in the charge time, lithium ions and oxygen ions are formed from lithium oxide or lithium peroxide at the positive electrode 2 as shown in the following formulae. The formed lithium ions migrate into the negative electrode 3 and are reduced at the negative electrode 3 to thereby deposit as metallic lithium.

(Positive Electrode) 2Li₂O→4Li⁺+2O²⁻
a. Li₂O₂→2Li⁺+2O²⁻

(Negative Electrode) 4Li⁺+4e⁻→4Li

At this time, since the positive electrode 2 contains the YMn₁₋ₓAₓO₃ having a conductivity as the oxygen-storing material, the transfer of electrons in the redox reaction of lithium ions carried out on particles of the oxygen-storing material can be carried out smoothly, and the reaction overpotential can be reduced.

Although in the oxygen-storing material in the discharge or the charge time described above, the occlusion and release of oxygen involves the formation and dissociation of a chemical bond, the adsorption and desorption of oxygen on and from the surface can be carried out only by an energy corresponding to an intermolecular force. Therefore, for the battery reaction at the positive electrode 2, oxygen adsorbed on and desorbed from the surface of the oxygen-storing material is preferentially used, allowing suppression of a decrease in the reaction rate and a rise in the overpotential.

At this time, use of the YMn₁₋ₓAₓO₃ as the oxygen-storing material for the positive electrode 2 can increase the oxygen amount adsorbed on the surface of the oxygen-storing material. Therefore, the metal oxygen battery 1 according to the present embodiment can provide also an effect of increasing the discharge capacity.

Then, Examples and Comparative Examples are shown.

### EXAMPLE 1

In the present Example, first, yttrium nitrate pentahydrate, manganese nitrate hexahydrate, ruthenium nitrate and malic acid in a molar ratio of 1:0.8:0.2:6 were crushed and mixed to thereby obtain a mixture of a composite metal oxide material. Then, the obtained mixture of the composite metal oxide material was reacted at a temperature of 250° C. for 30 min, and thereafter further reacted at a temperature of 300° C. for 30 min and at a temperature of 350° C. for 1 hour. Then, the mixture of the reaction product was crushed and mixed, and thereafter calcined at a temperature of 1,000° C. for 1 hour to thereby obtain a composite metal oxide.

The composite metal oxide obtained in the present Example was confirmed to be a composite metal oxide represented by the chemical formula YMn_{0.8}Ru_{0.2}O₃ and have a hexagonal structure by an X-ray diffractometry pattern. The average particle diameter D50 of the obtained composite metal oxide was calculated by using a laser diffraction/scattering type particle size distribution measuring apparatus (made by HORIBA Ltd.) and using ethanol as a solvent, and the calculation revealed that the obtained composite metal oxide had an average particle diameter of 5.75 μm.

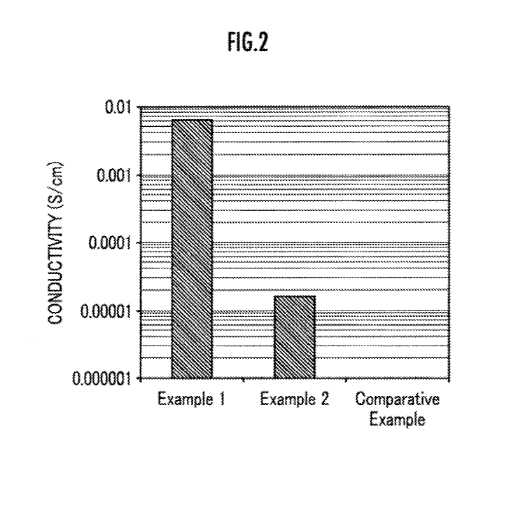

Then, the conductivity of the YMn_{0.8}Ru_{0.2}O₃ obtained in the present Example is shown in FIG. 2.

Then, the YMn_{0.8}Ru_{0.2}O₃ obtained in the present Example as an oxygen-storing material, Ketjen Black (made by Lion Corp.) as a conductive material, and a polytetrafluoroethylene (made by Daikin Industries, Ltd.) as a binder were mixed in a mass ratio of 10:80:10 to thereby obtain a positive electrode mixture. Then, the obtained positive electrode mixture was press bonded at a pressure of 5 MPa on a positive electrode current collector 9 composed of a titanium mesh to thereby form a positive electrode 2 of 15 mm in diameter and 1 mm in thickness.

The positive electrode 2 was measured for the porosity by the mercury intrusion method using a fully automatic pore distribution measuring apparatus (made by Quantachrome Corp.), and the measurement revealed that the positive electrode 2 had a porosity of 78% by volume.

Then, a negative electrode current collector 10 of 15 mm in diameter composed of a copper mesh was arranged inside a bottomed cylindrical SUS-made case body 6 of 15 mm in inner diameter, and a negative electrode 3 of 15 mm in diameter and 0.1 mm in thickness composed of metallic lithium was superposed on the negative electrode current collector 10.

Then, a separator of 15 mm in diameter composed of a glass fiber (made by Nippon Sheet Glass Co., Ltd.) was superposed on the negative electrode 3. Then, the positive electrode 2 and the positive electrode current collector 9 obtained as described above were superposed on the separator so that the positive electrode 2 contacted with the separator. Then, a nonaqueous electrolyte solution was injected in the separator to thereby form an electrolyte layer 4.

The nonaqueous electrolyte solution used was a solution (made by Kishida Chemical Co., Ltd.) in which lithium hexafluorophosphate (LiPF₆) as a supporting salt was dissolved in a concentration of 1 mol/L in a solvent which was a mixed solution prepared by mixing ethylene carbonate and diethyl carbonate in a mass ratio of 50:50.

Then, a laminate comprising the negative electrode current collector 10, the negative electrode 3, the electrolyte layer 4, the positive electrode 2, and the positive electrode current collector 9 accommodated in the case body 6 was closed by a bottomed cylindrical SUS-made lid body 7 of 15 mm in inner diameter. At this time, a ring-shape insulating resin 8 of 32 mm in outer diameter, 30 mm in inner diameter and 5 mm in thickness composed of a polytetrafluoroethylene (PTFE) was disposed between the case body 6 and the lid body 7 to thereby obtain a metal oxygen battery 1 shown in FIG. 1.

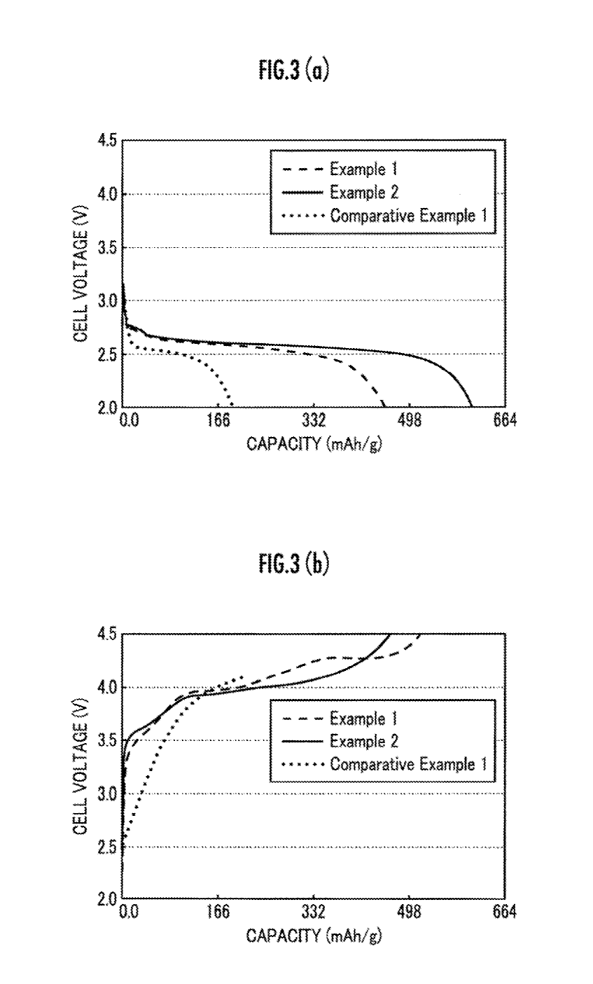

Then, the metal oxygen battery 1 obtained in the present Example was loaded on an electrochemical measuring apparatus (made by Toho Technical Research Co., Ltd.); and a current of 0.2 mA/cm² was applied between the negative electrode 3 and the positive electrode 2, and the discharge was carried out until the cell voltage became 2.0 V. The relationship between the cell voltage and the discharge capacity at this time is shown in FIG. 3(a).

Then, the metal oxygen battery 1 obtained in the present Example was loaded on the electrochemical measuring apparatus; and a current of 0.2 mA/cm² was applied between the negative electrode 3 and the positive electrode 2, and the charge was carried out until the cell voltage became 4.5 V. The relationship between the cell voltage and the charge capacity at this time is shown in FIG. 3(b).

### EXAMPLE 2

In the present Example, a metal oxygen battery 1 was manufactured wholly as in Example 1, except for using nickel nitrate in place of ruthenium nitrate to obtain a composite metal oxide represented by the chemical formula YMn_{0.8}Ni_{0.2}O₃. The conductivity of the YMn_{0.8}Ni_{0.2}O₃ obtained in the present Example is shown in FIG. 2.

Then, the charge and the discharge were carried out wholly as in Example 1, except for using the metal oxygen battery 1 obtained in the present Example. The relationship between the cell voltage and the discharge capacity at this time is shown in FIG. 3(a), and the relationship between the cell voltage and the charge capacity at this time is shown in FIG. 3(b).

### COMPARATIVE EXAMPLE 1

In the present Comparative Example, a metal oxygen battery 1 was manufactured wholly as in Example 1, except for using no ruthenium nitrate nor nickel nitrate at all to obtain a composite metal oxide represented by the chemical formula YMnO₃. The conductivity of the YMnO₃ obtained in the present Comparative Example is shown in FIG. 2.

Then, the charge and the discharge were carried out wholly as in Example 1, except for using the metal oxygen battery 1 obtained in the present Comparative Example. The relationship between the cell voltage and the discharge capacity at this time is shown in FIG. 3(a), and the relationship between the cell voltage and the charge capacity at this time is shown in FIG. 3(b).

It is clear from FIG. 2 that the YMn_{0.8}Ru_{0.2}O₃ obtained in Example 1 and the YMn_{0.8}Ni_{0.2}O₃ obtained in Example 2 had excellent conductivities. By contrast, it is clear that the YMnO₃ obtained in Comparative Example 1 exhibited substantially no conductivity, and was an electron insulator.

It is also clear from FIG. 3 that the respective metal oxygen batteries 1 of Example 1 and Example 2 containing the YMn_{0.8}Ru_{0.2}O₃ and the YMn_{0.8}Ni_{0.2}O₃ having conductivities as the oxygen-storing material had larger discharge capacities and lower charge and discharge overpotentials (reaction overpotentials) than the metal oxygen battery 1 of Comparative Example 1 containing YMnO₃ as the oxygen-storing material.

### EXAMPLE 3

In the present Example, yttrium nitrate pentahydrate, manganese nitrate hexahydrate, cobalt nitrate and malic acid in a molar ratio of 1:0.8:0.2:6 were crushed and mixed to thereby obtain a mixture of a composite metal oxide material. Then, the obtained mixture of the composite metal oxide material was reacted at a temperature of 250° C. for 30 min, and thereafter further reacted at a temperature of 300° C. for 30 min and at a temperature of 350° C. for 1 hour. Then, the mixture of the reaction product was crushed and mixed, and thereafter calcined at a temperature of 850° C. for 1 hour to thereby obtain a composite metal oxide represented by the chemical formula YMn_{0.8}Co_{0.2}O₃.

Then, the YMn_{0.8}Co_{0.2}O₃ obtained in the present Example, Ketjen Black (made by Lion Corp.) as a conductive material, a polytetrafluoroethylene (made by Daikin Industries, Ltd.) as a binder, and lithium peroxide (made by Kojundo Chemical Laboratory Co., Ltd.) as a lithium compound were mixed in a mass ratio of 8:1:1:4 to thereby obtain a positive electrode mixture. Then, the obtained positive electrode mixture was applied on a positive electrode current collector 9 composed of an aluminum mesh to thereby form a positive electrode 2 of 15 mm in diameter and 0.4 mm in thickness.

Then, a negative electrode current collector 10 of 15 mm in diameter composed of a SUS mesh was arranged inside a bottomed cylindrical SUS-made case body 6 of 15 mm in inner diameter, and a negative electrode 3 of 15 mm in diameter and 0.1 mm in thickness composed of metallic lithium was superposed on the negative electrode current collector 10.

Then, a separator of 15 mm in diameter composed of a polyolefin flat membrane (made by Asahi Kasei E-Materials Corp.) was superposed on the negative electrode 3. Then, the positive electrode 2 and the positive electrode current collector 9 obtained as described above was superposed on the separator so that the positive electrode 2 contacted with the separator. Then, a nonaqueous electrolyte solution was injected in the separator to thereby form an electrolyte layer 4.

The nonaqueous electrolyte solution used was a solution (made by Kishida Chemical Co., Ltd.) in which lithium bis(trifluoromethanesulfonyl)imide (LiTFSI) as a supporting salt was dissolved in a concentration of 1 mol/L in a solvent which was dimethoxyethane.

Then, a laminate comprising the negative electrode current collector 10, the negative electrode 3, the electrolyte layer 4, the positive electrode 2, and the positive electrode current collector 9 accommodated in the case body 6 was closed by a bottomed cylindrical SUS-made lid body 7 of 15 mm in inner diameter. At this time, a ring-shape insulating resin 8 of 32 mm in outer diameter, 30 mm in inner diameter and 5 mm in thickness composed of a polytetrafluoroethylene (PTFE) was disposed between the case body 6 and the lid body 7 to thereby obtain a metal oxygen battery 1 shown in FIG. 1.

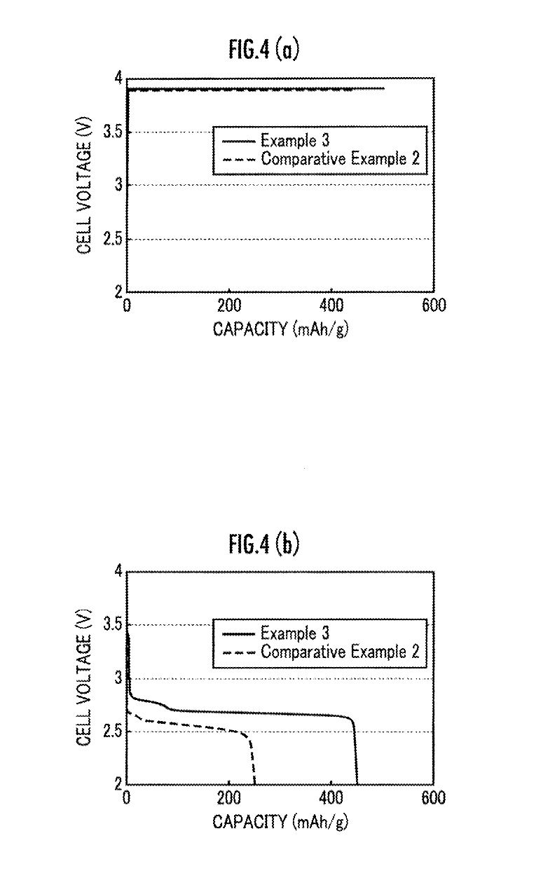

Then, the metal oxygen battery 1 obtained in the present Example was loaded on an electrochemical measuring apparatus (made by Toho Technical Research Co., Ltd.); and a current of 0.2 mA/cm² was applied between the negative electrode 3 and the positive electrode 2, and the constant-current charge was carried out until the cell voltage became 3.9 V. The charge was switched to the constant-voltage charge at the time when the cell voltage reached 3.9 V, and carried out until the current value became 0.015 mA/cm². The relationship between the cell voltage and the charge capacity at this time is shown in FIG. 4(a).

Then, the metal oxygen battery 1 obtained in the present Example was loaded on the electrochemical measuring apparatus; and a current of 0.2 mA/cm² was applied between the negative electrode 3 and the positive electrode 2, and the discharge was carried out until the cell voltage became 2.0 V. The relationship between the cell voltage and the discharge capacity at this time is shown in FIG. 4(b).

### EXAMPLE 4

In the present Example, a composite metal oxide represented by the chemical formula YMn_{0.8}Co_{0.2}O₃ was obtained wholly as in Example 3, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.8}Co_{0.2}O₃ obtained in the present Example.

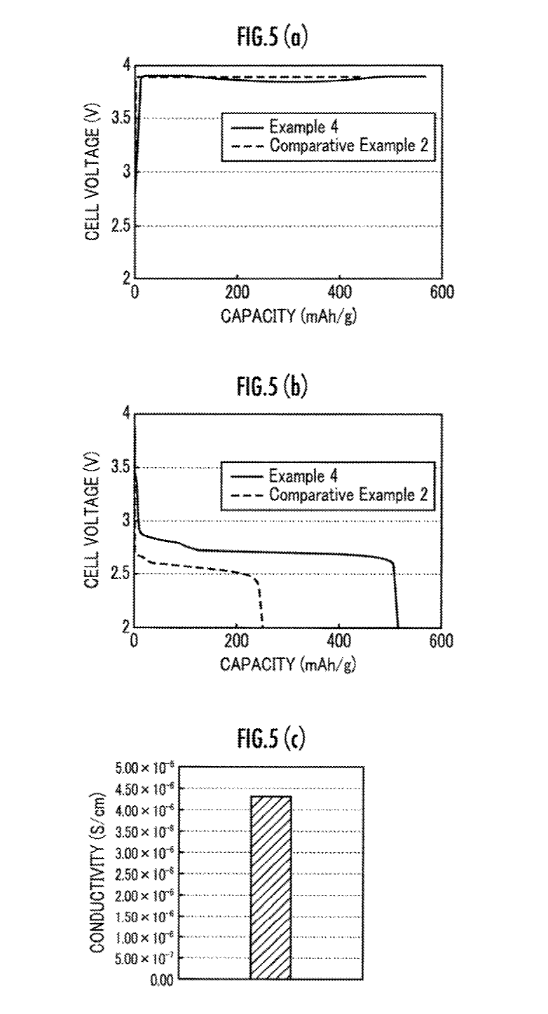

Then, the charge and the discharge were carried out wholly as in Example 3, except for using the metal oxygen battery 1 obtained in the present Example. The relationship between the cell voltage and the charge capacity in the charge time is shown in FIG. 5(a), and the relationship between the cell voltage and the discharge capacity in the discharge time is shown in FIG. 5(b). The conductivity of the YMn_{0.8}Co_{0.2}O₃ obtained in the present Example is shown in FIG. 5(c).

### EXAMPLE 5

In the present Example, a composite metal oxide represented by the chemical formula YMn_{0.9}Co_{0.1}O₃ was obtained wholly as in Example 3, except for crushing and mixing yttrium nitrate pentahydrate, manganese nitrate hexahydrate, cobalt nitrate and malic acid in a molar ratio of 1:0.9:0.1:6 to obtain a mixture of a composite metal oxide material.

Then, a metal oxygen battery 1 shown in FIG. 1 was obtained wholly as in Example 3, except for using the YMn_{0.9}Co_{0.1}C₃ obtained in the present Example.

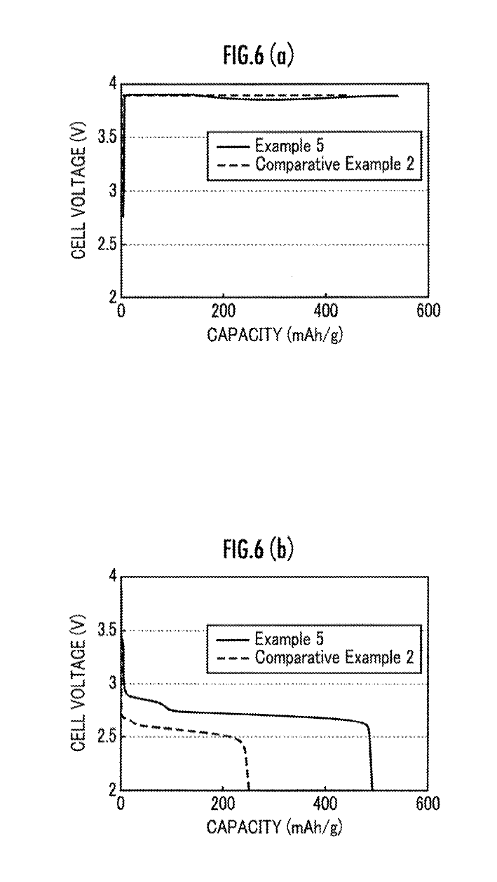

Then, the charge and the discharge were carried out wholly as in Example 3, except for using the metal oxygen battery 1 obtained in the present Example. The relationship between the cell voltage and the charge capacity in the charge time is shown in FIG. 6(a), and the relationship between the cell voltage and the discharge capacity in the discharge time is shown in FIG. 6(b).

### EXAMPLE 6

In the present Example, a composite metal oxide represented by the chemical formula YMn_{0.9}Co_{0.1}O₃ was obtained wholly as in Example 5, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.9}Co_{0.1}O₃ obtained in the present Example.

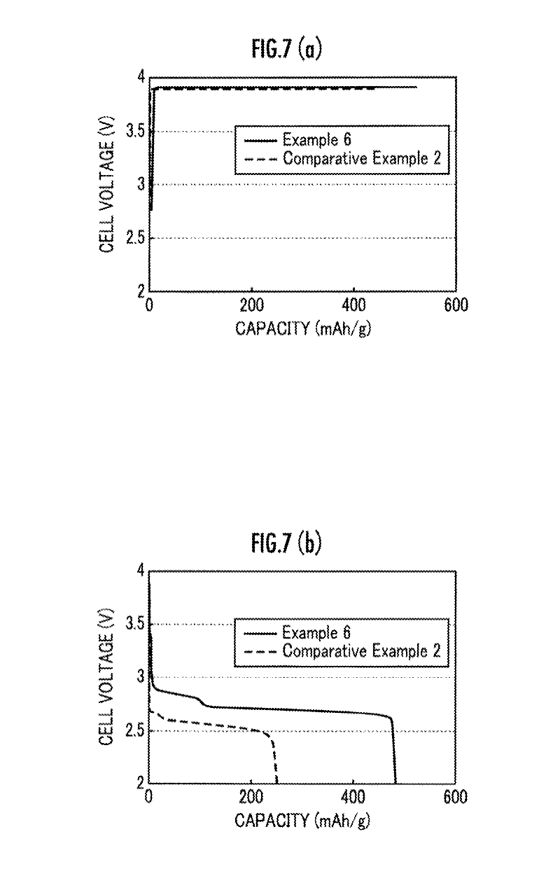

Then, the charge and the discharge were carried out wholly as in Example 3, except for using the metal oxygen battery 1 obtained in the present Example. The relationship between the cell voltage and the charge capacity in the charge time is shown in FIG. 7(a), and the relationship between the cell voltage and the discharge capacity in the discharge time is shown in FIG. 7(b).

### EXAMPLE 7

In the present Example, a composite metal oxide represented by the chemical formula YMn_{0.95}Co_{0.05}O₃ was obtained wholly as in Example 3, except for crushing and mixing yttrium nitrate pentahydrate, manganese nitrate hexahydrate, cobalt nitrate and malic acid in a molar ratio of 1:0.95:0.05:6 to obtain a mixture of a composite metal oxide material.

Then, a metal oxygen battery 1 shown in FIG. 1 was obtained wholly as in Example 3, except for using the YMn_{0.95}Co_{0.05}O₃ obtained in the present Example.

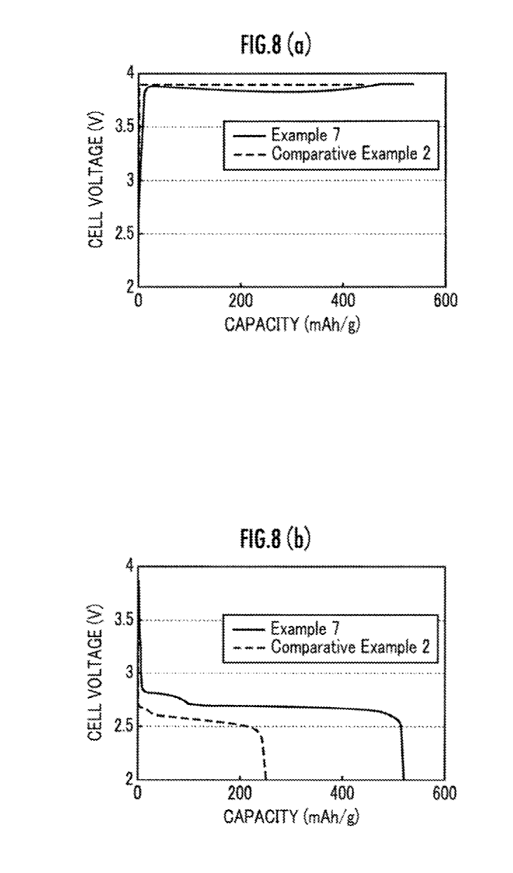

Then, the charge and the discharge were carried out wholly as in Example 3, except for using the metal oxygen battery 1 obtained in the present Example. The relationship between the cell voltage and the charge capacity in the charge time is shown in FIG. 8(a), and the relationship between the cell voltage and the discharge capacity in the discharge time is shown in FIG. 8(b).

### EXAMPLE 8

In the present Example, a composite metal oxide represented by the chemical formula YMn_{0.95}Co_{0.05}O₃ was obtained wholly as in Example 7, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.95}Co_{0.05}O₃ obtained in the present Example.

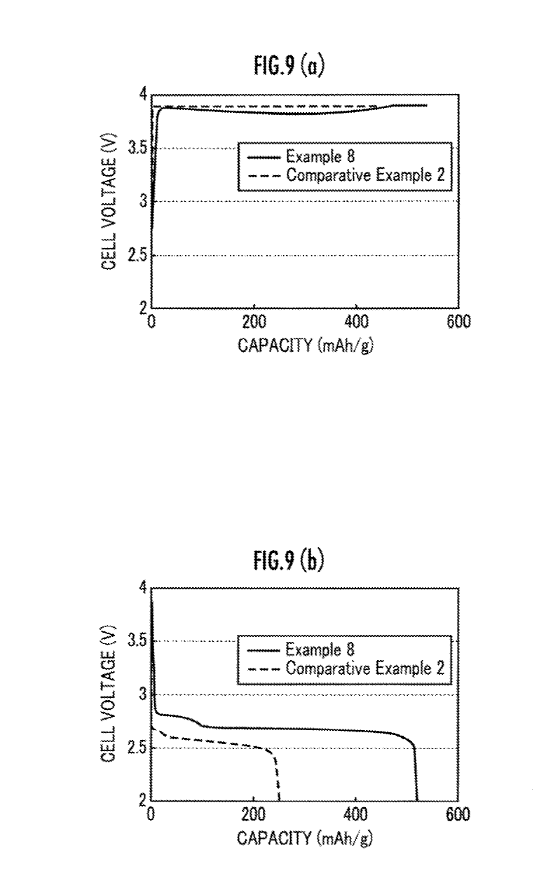

Then, the charge and the discharge were carried out wholly as in Example 3, except for using the metal oxygen battery 1 obtained in the present Example. The relationship between the cell voltage and the charge capacity in the charge time is shown in FIG. 9(a), and the relationship between the cell voltage and the discharge capacity in the discharge time is shown in FIG. 9(b).

### EXAMPLE 9

In the present Example, a composite metal oxide represented by the chemical formula YMn_{0.8}Ni_{0.2}O₃ was obtained wholly as in Example 3, except for using nickel nitrate in place of cobalt nitrate.

Then, a metal oxygen battery 1 shown in FIG. 1 was obtained wholly as in Example 3, except for using the YMn_{0.8}Ni_{0.2}O₃ obtained in the present Example.

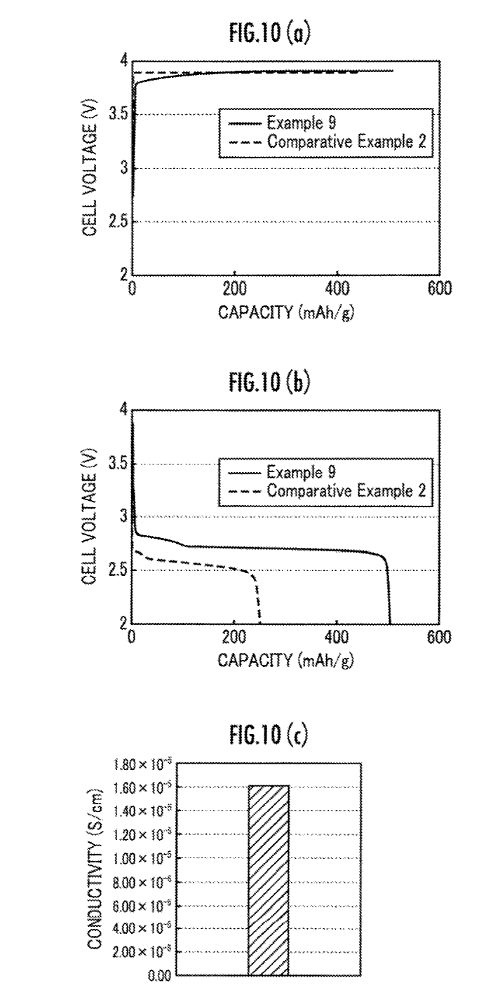

Then, the charge and the discharge were carried out wholly as in Example 3, except for using the metal oxygen battery 1 obtained in the present Example. The relationship between the cell voltage and the charge capacity in the charge time is shown in FIG. 10(a), and the relationship between the cell voltage and the discharge capacity in the discharge time is shown in FIG. 10(b). The conductivity of the YMn_{0.8}Ni_{0.2}O₃ obtained in the present Example is shown in FIG. 10(c).

### EXAMPLE 10

In the present Example, a composite metal oxide represented by the chemical formula YMn_{0.8}Ni_{0.2}O₃ was obtained wholly as in Example 9, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.8}Ni_{0.2}O₃ obtained in the present Example.

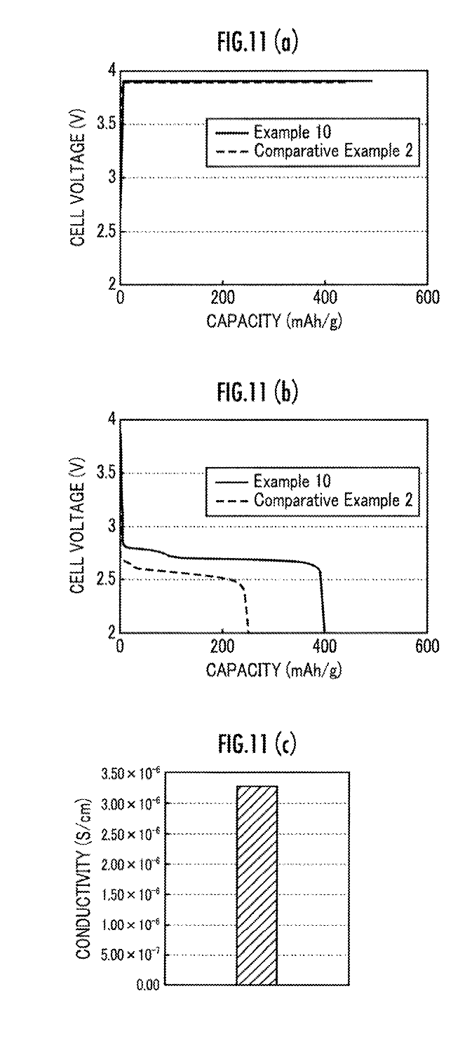

Then, the charge and the discharge were carried out wholly as in Example 3, except for using the metal oxygen battery 1 obtained in the present Example. The relationship between the cell voltage and the charge capacity in the charge time is shown in FIG. 11(a), and the relationship between the cell voltage and the discharge capacity in the discharge time is shown in FIG. 11(b). The conductivity of the YMn_{0.8}Ni_{0.2}O₃ obtained in the present Example is shown in FIG. 11(c).

### EXAMPLE 11

In the present Example, a composite metal oxide represented by the chemical formula YMn_{0.9}Ni_{0.1}O₃ was obtained wholly as in Example 3, except for crushing and mixing yttrium nitrate pentahydrate, manganese nitrate hexahydrate, nickel nitrate and malic acid in a molar ratio of 1:0.9:0.1:6 to obtain a mixture of a composite metal oxide material.

Then, a metal oxygen battery 1 shown in FIG. 1 was obtained wholly as in Example 3, except for using the YMn_{0.9}Ni_{0.1}O₃ obtained in the present Example.

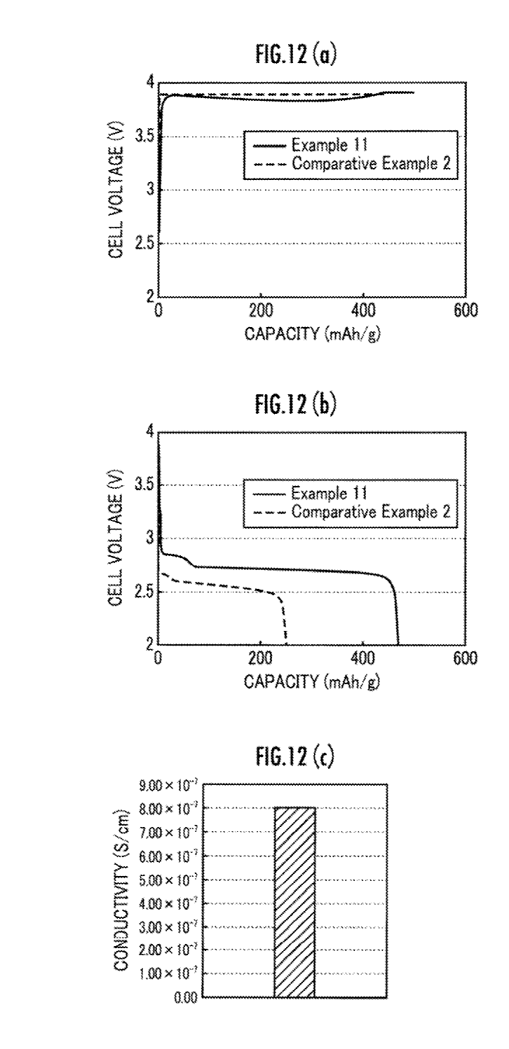

Then, the charge and the discharge were carried out wholly as in Example 3, except for using the metal oxygen battery 1 obtained in the present Example. The relationship between the cell voltage and the charge capacity in the charge time is shown in FIG. 12(a), and the relationship between the cell voltage and the discharge capacity in the discharge time is shown in FIG. 12(b). The conductivity of the YMn_{0.9}Ni_{0.1}O₃ obtained in the present Example is shown in FIG. 12(c).

### EXAMPLE 12

In the present Example, a composite metal oxide represented by the chemical formula YMn_{0.9}Ni_{0.1}O₃ was obtained wholly as in Example 11, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.9}Ni_{0.1}O₃ obtained in the present Example.

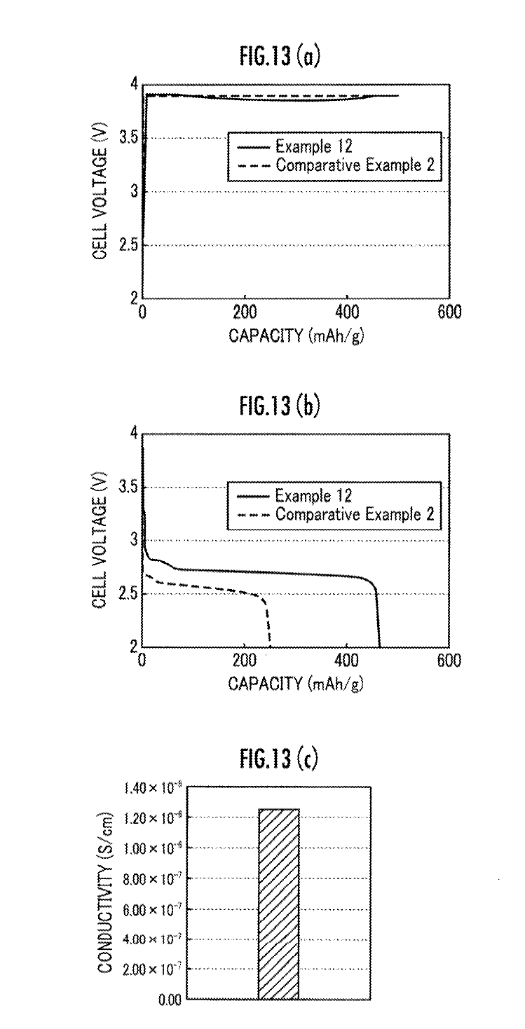

Then, the charge and the discharge were carried out wholly as in Example 3, except for using the metal oxygen battery 1 obtained in the present Example. The relationship between the cell voltage and the charge capacity in the charge time is shown in FIG. 13(a), and the relationship between the cell voltage and the discharge capacity in the discharge time is shown in FIG. 13(b). The conductivity of the YMn_{0.9}Ni_{0.1}O₃ obtained in the present Example is shown in FIG. 13(c).

### EXAMPLE 13

In the present Example, a composite metal oxide represented by the chemical formula YMn_{0.95}Ni_{0.05}O₃ was obtained wholly as in Example 3, except for crushing and mixing yttrium nitrate pentahydrate, manganese nitrate hexahydrate, nickel nitrate and malic acid in a molar ratio of 1:0.95:0.05:6 to obtain a mixture of a composite metal oxide material.

Then, a metal oxygen battery 1 shown in FIG. 1 was obtained wholly as in Example 3, except for using the YMn_{0.95}Ni_{0.05}O₃ obtained in the present Example.

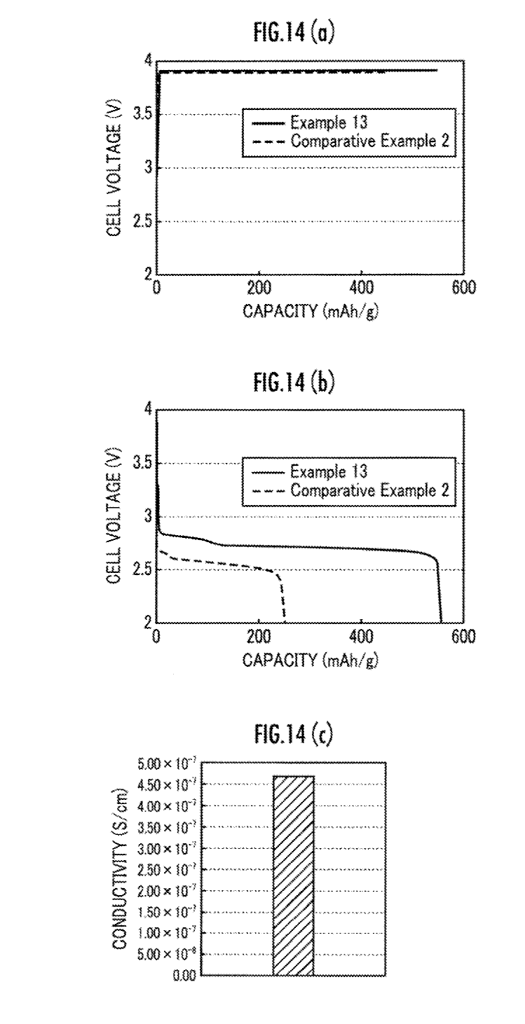

Then, the charge and the discharge were carried out wholly as in Example 3, except for using the metal oxygen battery 1 obtained in the present Example. The relationship between the cell voltage and the charge capacity in the charge time is shown in FIG. 14(a), and the relationship between the cell voltage and the discharge capacity in the discharge time is shown in FIG. 14(b). The conductivity of the YMn_{0.95}Ni_{0.05}O₃ obtained in the present Example is shown in FIG. 14(c).

### EXAMPLE 14

In the present Example, a composite metal oxide represented by the chemical formula YMn_{0.95}Ni_{0.05}O₃ was obtained wholly as in Example 13, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.95}Ni_{0.05}O₃ obtained in the present Example.

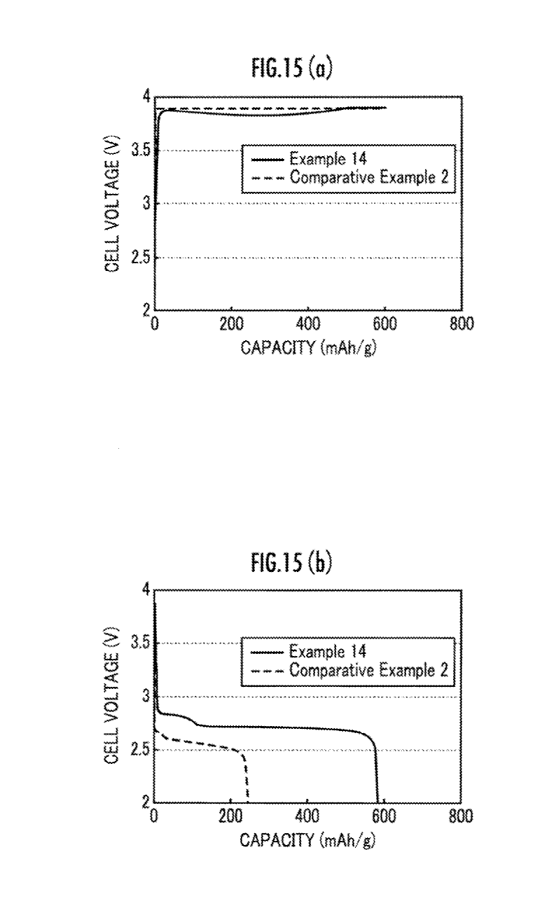

Then, the charge and the discharge were carried out wholly as in Example 3, except for using the metal oxygen battery 1 obtained in the present Example. The relationship between the cell voltage and the charge capacity in the charge time is shown in FIG. 15(a), and the relationship between the cell voltage and the discharge capacity in the discharge time is shown in FIG. 15(b).

### EXAMPLE 15

In the present Example, a composite metal oxide represented by the chemical formula YMn_{0.8}Ru_{0.2}O₃ was obtained wholly as in Example 3, except for using ruthenium nitrate in place of cobalt nitrate.

Then, a metal oxygen battery 1 shown in FIG. 1 was obtained wholly as in Example 3, except for using the YMn_{0.8}Ru_{0.2}O₃ obtained in the present Example.

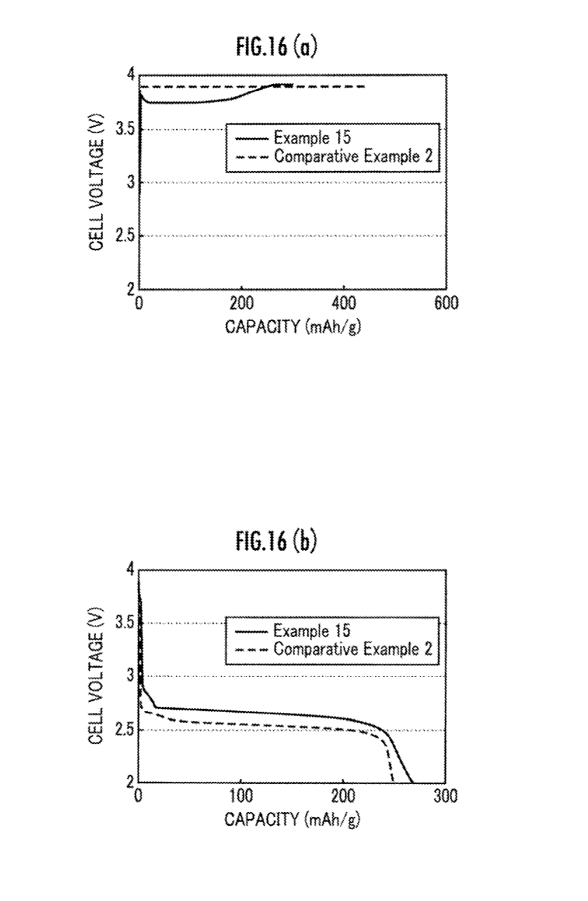

Then, the charge and the discharge were carried out wholly as in Example 3, except for using the metal oxygen battery 1 obtained in the present Example. The relationship between the cell voltage and the charge capacity in the charge time is shown in FIG. 16(a), and the relationship between the cell voltage and the discharge capacity in the discharge time is shown in FIG. 16(b).

### EXAMPLE 16

In the present Example, a composite metal oxide represented by the chemical formula YMn_{0.8}Ru_{0.2}O₃ was obtained wholly as in Example 15, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.8}Ru_{0.2}O₃ obtained in the present Example.

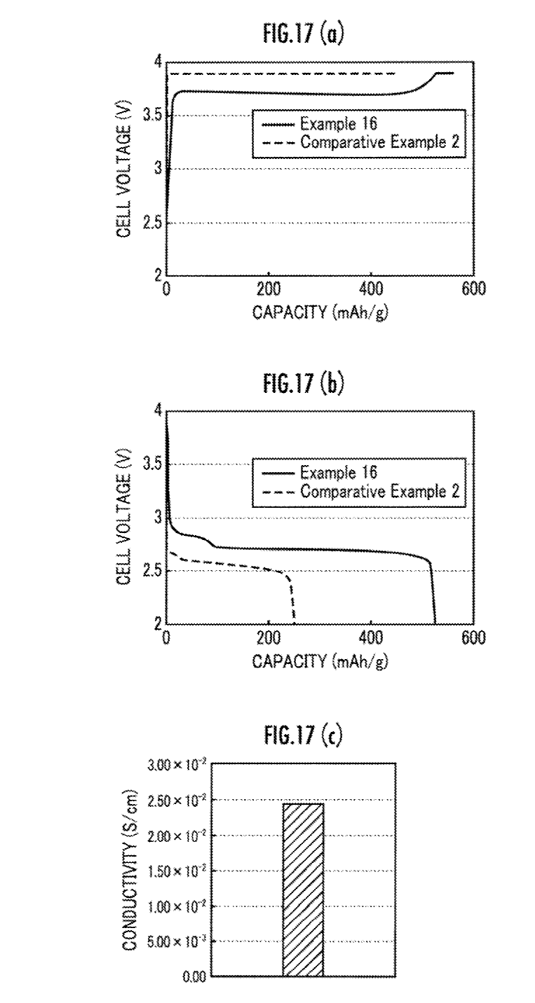

Then, the charge and the discharge were carried out wholly as in Example 3, except for using the metal oxygen battery 1 obtained in the present Example. The relationship between the cell voltage and the charge capacity in the charge time is shown in FIG. 17(a), and the relationship between the cell voltage and the discharge capacity in the discharge time is shown in FIG. 17(b). The conductivity of the YMn_{0.8}Ru_{0.2}O₃ obtained in the present Example is shown in FIG. 17(c).

### EXAMPLE 17

In the present Example, a composite metal oxide represented by the chemical formula YMn_{0.9}Ru_{0.1}O₃ was obtained wholly as in Example 3, except for crushing and mixing yttrium nitrate pentahydrate, manganese nitrate hexahydrate, ruthenium nitrate and malic acid in a molar ratio of 1:0.9:0.1:6 to obtain a mixture of a composite metal oxide material.

Then, a metal oxygen battery 1 shown in FIG. 1 was obtained wholly as in Example 3, except for using the YMn_{0.9}Ru_{0.1}O₃ obtained in the present Example.

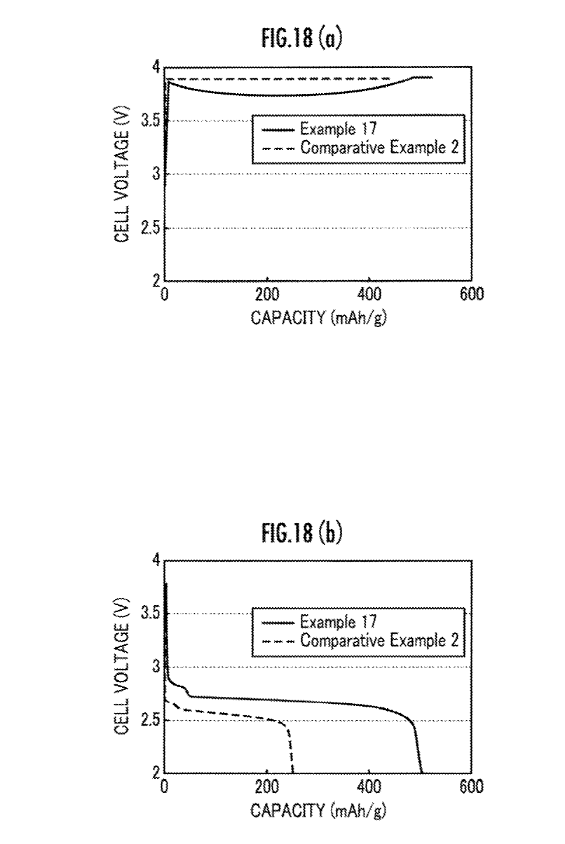

Then, the charge and the discharge were carried out wholly as in Example 3, except for using the metal oxygen battery 1 obtained in the present Example. The relationship between the cell voltage and the charge capacity in the charge time is shown in FIG. 18(a), and the relationship between the cell voltage and the discharge capacity in the discharge time is shown in FIG. 18(b).

### EXAMPLE 18

In the present Example, a composite metal oxide represented by the chemical formula YMn_{0.9}Ru_{0.1}O₃ was obtained wholly as in Example 17, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.9}Ru_{0.1}O₃ obtained in the present Example.

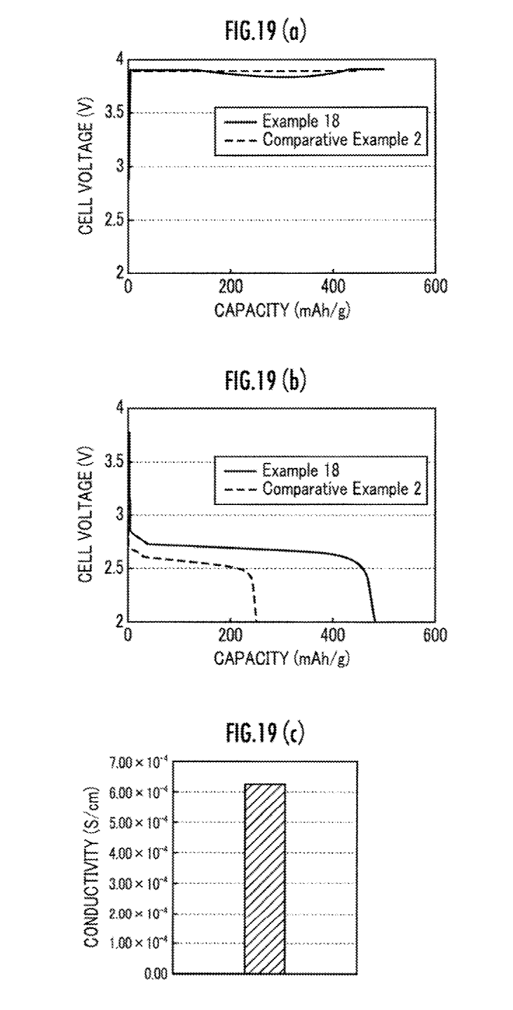

Then, the charge and the discharge were carried out wholly as in Example 3, except for using the metal oxygen battery 1 obtained in the present Example. The relationship between the cell voltage and the charge capacity in the charge time is shown in FIG. 19(a), and the relationship between the cell voltage and the discharge capacity in the discharge time is shown in FIG. 19(b). The conductivity of the YMn_{0.9}Ru_{0.1}O₃ obtained in the present Example is shown in FIG. 19(c).

### EXAMPLE 19

In the present Example, a composite metal oxide represented by the chemical formula YMn_{0.95}Ru_{0.05}O₃ was obtained wholly as in Example 3, except for crushing and mixing yttrium nitrate pentahydrate, manganese nitrate hexahydrate, ruthenium nitrate and malic acid in a molar ratio of 1:0.95:0.05:6 to obtain a mixture of a composite metal oxide material.

Then, a metal oxygen battery 1 shown in FIG. 1 was obtained wholly as in Example 3, except for using the YMn_{0.95}Ru_{0.05}O₃ obtained in the present Example.

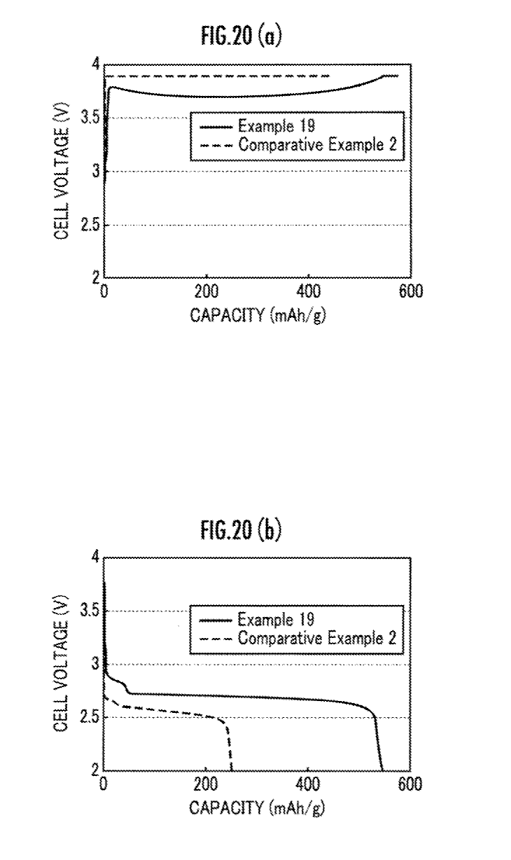

Then, the charge and the discharge were carried out wholly as in Example 3, except for using the metal oxygen battery 1 obtained in the present Example. The relationship between the cell voltage and the charge capacity in the charge time is shown in FIG. 20(a), and the relationship between the cell voltage and the discharge capacity in the discharge time is shown in FIG. 20(b).

### EXAMPLE 20

In the present Example, a composite metal oxide represented by the chemical formula YMn_{0.95}Ru_{0.05}O₃ was obtained wholly as in Example 19, except for calcining the crushed mixture after the crushing and mixing of the mixture of the reaction product obtained from the mixture of the composite metal oxide material, at a temperature of 1,000° C. for 1 hour.

Then, a metal oxygen battery 1 shown in FIG. 1 was obtained wholly as in Example 3, except for using the YMn_{0.95}Ru_{0.05}O₃ obtained in the present Example.

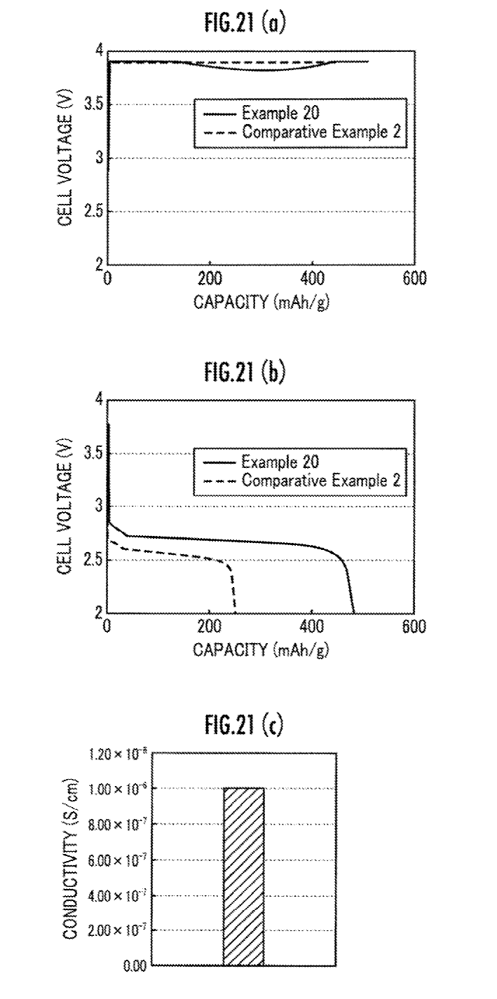

Then, the charge and the discharge were carried out wholly as in Example 3, except for using the metal oxygen battery 1 obtained in the present Example. The relationship between the cell voltage and the charge capacity in the charge time is shown in FIG. 21(a), and the relationship between the cell voltage and the discharge capacity in the discharge time is shown in FIG. 21(b). The conductivity of the YMn_{0.95}Ru_{0.05}O₃ obtained in the present Example is shown in FIG. 21(c).

### COMPARATIVE EXAMPLE 2

In the present Comparative Example, a metal oxygen battery 1 shown in FIG. 1 was obtained wholly as in Example 3, except for using none of cobalt nitrate, ruthenium nitrate and nickel nitrate at all to obtain a composite metal oxide represented by the chemical formula YMnO₃.

The charge and the discharge were carried out wholly as in Example 3, except for using the metal oxygen battery obtained in the present Comparative Example. The relationship between the cell voltage and the discharge capacity at this time is shown in FIGS. 4 to 21 together with the relationships between the cell voltage and the discharge capacity in Examples 3 to 20 in the metal oxygen battery 1.

It is clear from each FIG. (c) of FIGS. 10 to 14, 17, 19 and 21 that the composite metal oxides represented by the chemical formula YMn₁₋ₓAₓO₃ (A=Ru, Ni, Co, 0.05≦x≦0.2) and obtained in Examples 4, 9 to 13, 16, 18 and 20 had excellent conductivities.

It is also clear from each FIG. (a) and each FIG. (b) of FIGS. 4 to 21 that the metal oxygen batteries 1 of Examples 3 to 20 containing the YMn₁₋ₓAₓO₃ (A=Ru, Ni, Co, 0.05≦x≦0.2) having a conductivity as the oxygen-storing material had larger discharge capacities and lower charge and discharge overpotentials (reaction overpotentials) than the metal oxygen battery 1 of Comparative Example 2 containing YMnO₃ as the oxygen-storing material.

What is claimed is:

1. A metal oxygen battery, comprising:
a positive electrode to which oxygen is applied as an active substance;
a negative electrode to which metallic lithium is applied as an active substance; and
an electrolyte layer interposed between the positive electrode and the negative electrode,
wherein the positive electrode comprises an oxygen-storing material comprising YMn₁₋ₓAₓO₃ wherein A=Ru, Ni, or Co, and 0.01≦x≦0.2.

2. The metal oxygen battery according to claim 1, wherein the positive electrode comprises an oxygen-storing material comprising YMn₁₋ₓAₓO₃ wherein A=Ru, Ni, or Co, and 0.05≦x≦0.2.

3. The metal oxygen battery according to claim 1, wherein the positive electrode comprises the oxygen-storing material, a conductive material, and a binder.

4. The metal oxygen battery according to claim 1, wherein the positive electrode comprises the oxygen-storing material, a conductive material, a binder, and a lithium compound.

5. The metal oxygen battery according to claim 4, wherein the lithium compound comprises lithium peroxide.

6. The metal oxygen battery according to claim 1, wherein the positive electrode, the negative electrode, and the electrolyte layer are disposed in a hermetically sealed case.
